(19) United States
(12) Patent Application Publication
(10) Pub. No.: US 2014/0172568 A1
(43) Pub. Date: Jun. 19, 2014

(54) PI-TRAMPING Pages

(71) Applicant: Michael Alan Cunningham, Henderson, NV (US)

(72) Inventor: Michael Alan Cunningham, Henderson, NV (US)

(21) Appl. No.: 14/106,686

(22) Filed: Dec. 13, 2013

Related U.S. Application Data
(60) Provisional application No. 61/737,684, filed on Dec. 14, 2012.

(51) Int. Cl. G06Q 30/02

(52) U.S. Cl. CPC G06Q 30/0257
USPC 705/14.55

(57) ABSTRACT

PI-TRAMPING pages is an acronym for Programmed Immediate, Target Requested, Advertising Media Presentation on Individual, Neighborhood, and Generic pages. This is a method, scheme, program, or device for giving the viewer of an Internet Web page control over the presentation of all advertising associated with that Web page, thereby replacing in-your-face advertising with at-your-command advertising. This invention specifically allows the inclusion of features which will encourage the viewer of an Internet Web page to choose to look at the advertisements in a receptive state of mind and so satisfy the advertisers with allowing the display of their ads to be voluntary.

### CROSS-REFERENCE TO RELATED APPLICATIONS

This application claims the benefit of Provisional Patent Application Ser. No. 61/737,684 filed Dec. 14, 2012 by the same inventor.

### BACKGROUND

1. General Context

Advertising on Internet Web pages has encountered resistance from the viewers who have learned how, and become willing, to turn off the scripting and cookies and other features on which most advertising relies for presentation and target selection—sophisticated users of the Internet are discovering the Internet-generalized mute buttons to avoid distracting presentations of advertising. A great deal of internet advertising serves only to burn up transmission band-width and irritate potential customers

2. Prior Art

Typical state of the art practice for placing advertisements on Internet pages may be represented by two U.S. examples:

Patent Application Publication 2007/0180147 A1 by Colin Leigh published Aug. 2, 2007 and
U.S. Pat. No. 7,870,023B2 issued to Stuart Ozer et al. on Jan. 11, 2011.

### SUMMARY OF THE LOOK AND FEEL OF THE INVENTION

Envision a Web page clean and clear of any advertising, call it the Foundation Page. A small discrete trademark might indicate the availability of PI-TRAMPING pages. Moving the cursor, say off-page to the right (or some other voluntary action by the viewer, for example, a slight tilt of a hand-held device) slides onto the first, Generic page (G-Page) of advertising related specifically only to the Foundation Page (alternatively, an ad page might come on as a partial overlay to the Foundation Page or in some other way replace it). Continuing on to the second page (with the viewer action repeated) brings on a Neighborhood page (N-Page) of advertisers related to the Foundation Page and aimed or tailored more specifically to the current viewer (as betrayed by browsing history, cookies, Internet Service Provider, time of day, and other tracking devices which we need not name). Continuing on to the third page brings on an Individual's page (I-Page) of advertisers conforming to personally identified categories of interests (and thereby invited advertisers) actually requested by the current viewer, presently or as registered in the past. A reversal of the viewer actions returns to the ad-free Foundation Page. (The obvious extension of using the PI-TRAMPING page concept for other applications and in other directions off-screen, or beyond the PI-TRAMPING pages themselves, is a possibility that need not be elaborated here.)

The final Individual's Page is composed of ads related both to the Foundation Page and to topics the current individual viewer has specifically expressed an interest in (for example, honest banks, oxymorons, laptop computers that use standard size batteries, used cars). The viewer is logged on for a browsing session and identifies self with an online PI-TRAMPING identity and one of several passwords to control what might be presented while browsing. The viewer may, at some registration time, give key words or fill in forms to specify interests and preferences (such as minimum print size or language), or at any time make text selections and multi-key clicks anywhere on any Web page to register new specific interests which are maintained by the PI-TRAMPING Service which is itself paid by the advertisers and pays a share to the owner of the Foundation Page and is responsible for composing and hosting the I-Page, and for protecting the privacy of the individual viewer registered with the PI-TRAMPING Service even while mining the market data represented by the set of all individual viewers' requests. Without access to each individual viewer's account, advertisers may research the declared interests and preferences of the set of all viewers to satisfy groups of them with ads for offers, coupons, products, or whatever (which could then be passed on to appropriate I-Pages of individual viewers by the PI-TRAMPING Service). To encourage participation, an individual viewer need not even be physically identifiable or addressable, and so may feel certain to be free of uninvited molestation; the rising paranoia and distrust of EULA's and Privacy Policies and Controls is extinguished by having no need for them. An individual viewer should feel safe, secure, empowered, and in charge on that viewer's own I-Page, a kind of personal home page for advertising where all viewers can, at will, change or clear out their own interests and information collected about them—their power over their own I-Page will draw them repeatedly back to it from Foundation Pages they find interesting. They may select specific ads to be kept on their I-Pages like memos until they dismiss them or until the ads expire. They could request selected advertisers to send new ads directly to their I-Page. They could have the advertising emails which are just this side of spam forwarded to a read only mail box on their I-Page. They may be given various options to customize the look and feel of their I-Page style of presentation; they may sign in and sign out on it; they may prohibit from the start, or, after viewing, veto certain ads or advertisers or topics from appearing again on it; they may choose small entertainments or information services, such as weather or news or product price quotes, to appear on it; they may easily relay, through the PI-TRAMPING Service to the advertiser, approval or disapproval of, and other reactions to, specific ads, thus enabling a form of market research; they might even vote specific ads up or down, which vote, displayed on command near an ad, could drive disapproved ads from the I-Pages as the advertisers voluntarily withdraw them. On their I-Pages viewers with similar interests could exchange messages with other viewers of the associated Foundation Page. There might be a button on their I-Page that would randomly select and show some other viewer's recently displayed I-Page for the current Foundation Page without violating the other viewer's anonymity. They might even designate a favorite charity to receive a small fraction of the PI-TRAMPING Service's revenue generated by their viewing activity. Or, viewers could accumulate credits that could be applied to subscription fees for on-line periodicals. The point being that it should be pretty easy to attract viewers through the G- and N-Pages to their own I-Pages.

The middle Neighborhood page has ads related to the Foundation Page and targeted at the current viewer irrespective (except for the viewer's registered refusal and veto powers) of that viewer's explicitly expressed positive interests but using only passively shed information about interests (cookies, history, and such things as are presently used.). The PI-TRAMPING Service is paid by the advertisers and pays a share to the owner of the Foundation Page and is responsible for composing and hosting the N-Page. Also, the PI-TRAMPING Service and the Foundation Page owner might share management of this page; G-Page advertising could be fine tuned for the current viewer and reappear on the N-Page, or even the I-Page if it qualifies; on behalf of G-Page advertisers, the Foundation Page owner could exclude certain categories of competing ads on the N-Page; N-Page advertisers could sponsor information and service utilities or entertainments to appear and hold attention on the N-Page near their advertisements.

The beginning Generic page is composed of ads targeted at any and all viewers of the Foundation Page, who volunteer by moving the cursor off page. The owner of the Foundation Page composes the G-Page and is paid by the advertisers and pays a share to the PI-TRAMPING Service (particularly so if some control over what appears on the N-Page is required). Composing the page and hosting it may be shared with the advertisers. It is here that all traditional advertising is to be done, even while the total space available for advertising is more than tripled and a clear view of the Foundation Page free of advertising is made available.

Rather than just banners and column inches on the Foundation Page, full page ads become acceptable. Moreover, the PI-TRAMPING Service could make available for display on the G-Page any of the attention holding utilities used on its own N- and I-Pages.

The Foundation Page owner must agree to have no other advertising associated with that page actually displayed on it; such a clean page incites the viewer's curiosity and wonder. This form of advertising will be much more effective since the viewer will have actually requested it and invested some active interest in it and so be psychologically prepared to accept it. It will also be much more efficient and reduce bandwidth use by not broadcasting unwanted advertising that may be viewed with hostility anyway. There may be many fewer viewings, but each viewing will be much more effective. The scheme may be implemented within the Foundation Page itself, by scripts called in by the Foundation Page, or eventually as an installed or core part of the Web browser program. The availability of the ads may be enforced by the Foundation Page refusing to display otherwise. Alternatively the generic ads may appear on the Foundation Page unless or until the viewer logs on with a PI-TRAMPING online id.

The PI-TRAMPING Service will keep the Database of viewers' interests (registered and deduced), advertisers' targets, and Foundation Pages' key words which will be used to select advertisements for the I- and N-Pages. With successive views or on command from the viewer, the contents of the I- and N-Pages for a particular Foundation Page might be changed. To maintain interest in, and fill space on the I- and N-Pages some results of ordinary Internet searches using terms from the Foundation Page and the PI-TRAMPING database might be displayed as well as any other non-advertising utility content that might draw and hold the viewer's attention, for example, small interactive games and puzzles that can only be displayed on PI-TRAMPING pages (if they conform to viewers' controls for I-Page content and/or attract advertisers' sponsorship). Such games and puzzles might involve tramping around through advertisements looking for clues, for a particular ad, or a match to some specification, the point being, it should be pretty easy to satisfy advertisers' desire to be seen even if only on the reels of an advertising slot machine.

Some number of online identities for any viewer's use with no password, may be reserved for general interests which require no individual registration and would have no associated I-Page (democrat, republican, independent, slavish, doctor, artist, sweet sixteen, teetotaler, sport, worker, rich, poor, male, female, ignoramus, cognoscenti, . . . , the null ID, that is to say no ID at all). Any unrecognized user would be presented a first I-Page of explanation with log-on, sign-up and a list of reserved identities to use freely. Besides eliminating any need to sign up as a PI-TRAMPING Service user, such reserved identities that are open to all might excite many viewers' curiosity to investigate, leading them to sign-on with a reserved ID and tramp about just to see what kinds of pitches are made to the reserved id. Advertisers should not mind the traffic, and such open access may result in non-users deciding to register with the PI-TRAMPING Service to gain access to their own I-Pages and some control over what may be presented to them on any N-Pages. Moreover, the reserved identities would give the PI-TRAMPING Service an opportunity to display various options and styles for the look and feel of its advertising pages.

Blank PI-TRAMPING pages can be skipped but each I-, N-, or G-Page should be clearly identified as such. The order of presentation, G, N, I, is important to motivate Foundation Page owners and their advertisers to participate—their ads on the G-Page come first and get viewed again last on the way back to the Foundation Page. This order is also important to motivate viewers at least to move through the G- and N-Pages to get to their own tailored I-Page which comes last. The availability of the I-, N-, and G-Pages and their relative sizes compared to the Foundation Page might be suggested, on that page or amongst the browser's features, by a tickler trademark in the form of a four-colored pie chart on which the sizes of the colored segments might change while the Foundation Page is examined by the viewer and the I- and N-Pages composed; such subtle changes may act as an enticement to view the advertising. Presentation of the Foundation Page with no advertising will be faster, and the viewer's time spent studying it will allow time for the I-, N-, and G-Pages to be prepared. Any way of letting the viewer request the PI-TRAMPING pages would do, but using a cursor movement off-page rather than something like a click on a trademark, will occasionally provide some serendipitous views of the advertising.

Web pages with no advertising of their own, that is, no G-Page, could serve as a voluntary launch point for N- and I-Pages and the owners receive some reimbursement. Foundation Page owners with sensitivities might be allowed to forbid certain categories of ads on their related N-Page (but not the viewer's I-Page). Even a Web page with no connection to the PI-TRAMPING Service might be used as an involuntary Foundation Page from which the viewer could move directly onto an N- or I-Page, in effect passing the address or contents or analyzed contents of such a Web page to the PI-TRAMPING Service for a search for relevant ads (in particular, is there any competition for the pushy in-your-face ads already on the involuntary Foundation Page?; or, fed up with a bank's on-line service, just tramp two pages off screen for competitors' ads). PI-TRAMPING pages thus become universally available and every Internet Web page becomes an opportunity for unmolested viewers to think for themselves of actually looking for relevant ads where no advertiser had specifically thought to place them, or even been able to place them before. Moreover, a viewer checking in on an I-Page in essence volunteers to be tracked there, and independently of the specific hardware device used by the viewer at any particular time, that viewer's I-Page will be accessible. A universal wide open marketplace for advertising is thus created and placed finally under the complete command and control of each individual viewer.

### DRAWINGS

### Figures

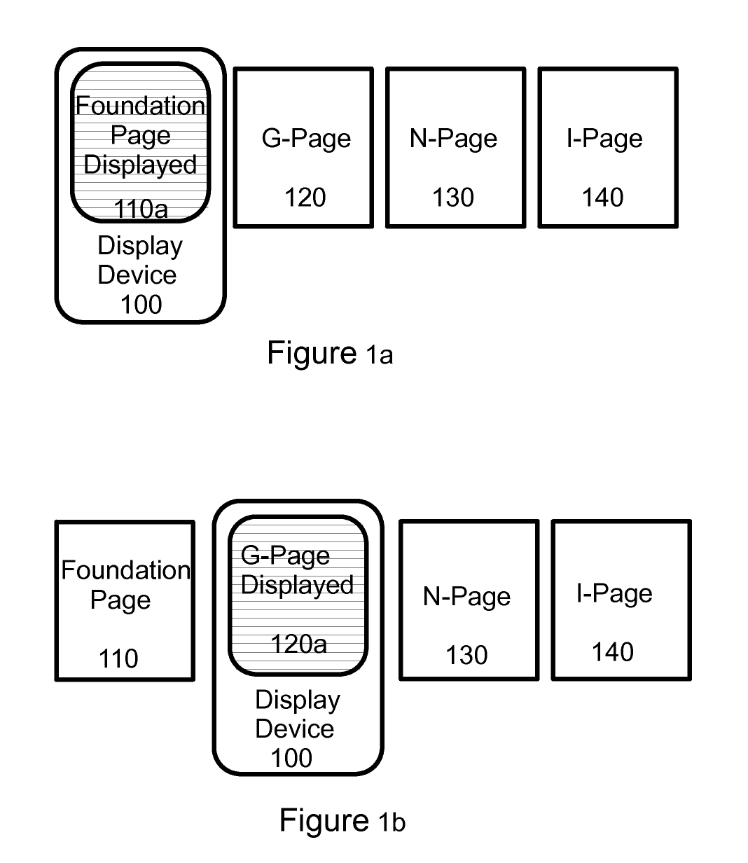

FIG. 1a. shows the conceptual framework of PI-TRAMPING pages off-screen as virtual images not yet displayed while a Foundation Page is displayed on the screen of an Internet connected computing display device.

FIG. 1b. Shows the same computing device as FIG. 1a, but after the Foundation Page has been replaced on the screen by the first page of PI-TRAMPING advertising.

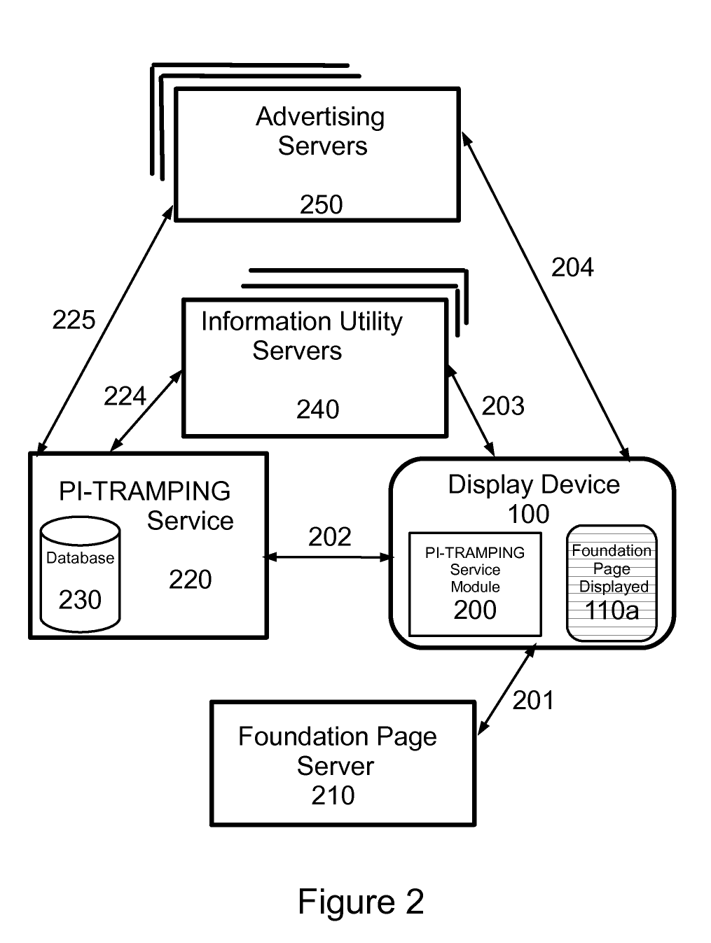

FIG. 2. shows the information exchange between an Internet connected computing display device, the PI-TRAMPING Service, and Internet Servers of Advertisers, Foundation Pages and Utility Services.

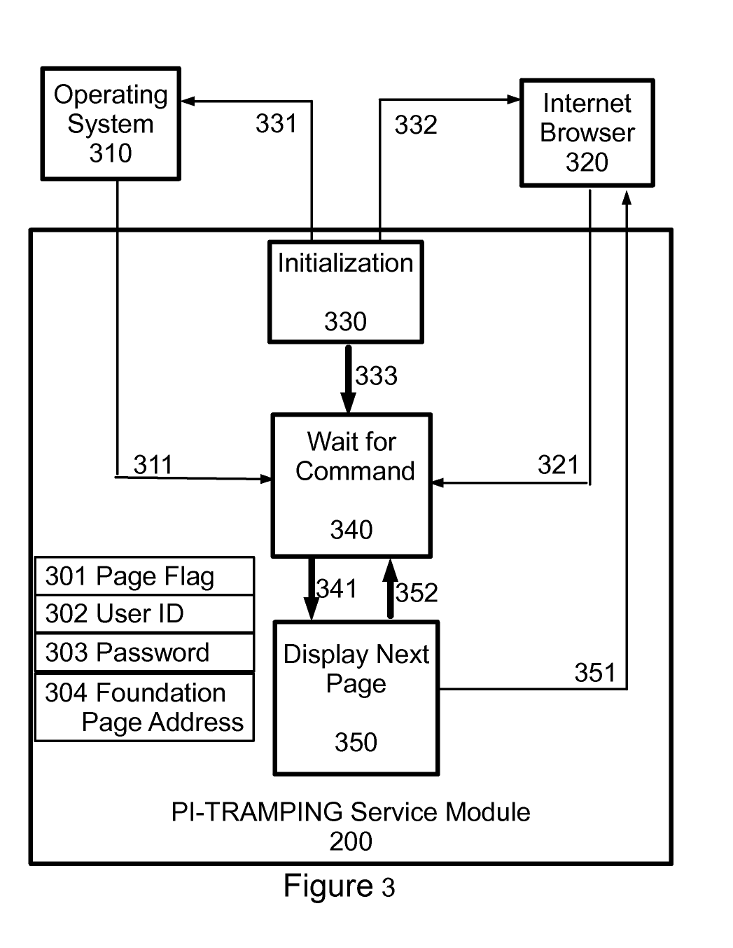

FIG. 3. is a flowchart of the operations of the PI-TRAMPING service module installed on an Internet connected computing display device.

### DRAWINGS

### Reference Numerals

100 An Internet connected computer display device (here after simply referred to as a Display Device) showing on its screen some Internet page.
110 Any page of the Internet may serve as a Foundation Page.
110a Any page from the Internet is displayed as a Foundation page from which other pages of advertising associated with it may be accessed and placed on display.
120 A first page of advertising that would traditionally have been placed directly on the Foundation page, is called here the G-Page, for Generic advertising. Before it is displayed, it is a virtual page that only exists as a file in the computers of the PI-TRAMPING Service.
120a The G-Page of advertising after it is put on the screen of a Display Device.
130 A second page of advertising is called here the N-Page (for Neighborhood advertising) which has been arranged for by the PI-TRAMPING Service and is only displayed after the traditional advertising arranged for by the owner of the Foundation-Page.
140 A third page of advertising is called here the I-Page (for Individual Page) which has been arranged for by the PI-TRAMPING Service and is tailored to match the interests of whatever individual is using the Display Device at the time.
200 The PI-TRAMPING Service Module contains programming to implement the transitions between the Foundation-Page and its associated pages of advertising.
201 Internet connections between the Display Device and the Foundation Page Server.
202 Internet connections between the Display Device and the PI-TRAMPING Service.
203 Internet connections between the Display Device and Information Utility Servers of which there may be several.
204 Internet connections between the Display Device and Advertising Servers of which there may be several.
210 A Foundation Page Server from which an Internet page may be requested and downloaded for display. There are many such Servers, but for the discussion here we need only consider a single example.
220 The PI-TRAMPING Service is here represented by as a Server which sends pages of advertising in response to requests from Display Devices running the PI-TRAMPING Service Module.
224 Internet connections between the PI-TRAMPING Service and the Information Utility Servers to arrange for material more attractive than advertising to appear on the N-Page and I-Page in order to lure viewers into accessing them.
225 Internet connections between the PI-TRAMPING Service and the Advertising Servers for arranging for the presentation of advertisements on the pages that will be sent out by the PI-TRAMPING Service.
230 The Database the PI-TRAMPING Service will maintain to match advertisements to the individual interests of the viewers of it serves.
240 Information Utility Servers provide material more attractive than advertising to appear on the N-Page and I-Page in order to lure viewers into accessing them.
250 Advertising Servers provide the files from which the advertising pages are built.
301 The Page Flag is used by the PI-TRAMPING Service Module to keep track which of the PI-TRAMPING pages is currently on display.
302 The User ID retains the identity of the person currently viewing Internet pages on the Display Device.
303 The Password retains a password to help verify the identity of the current user.
304 The Foundation Page Address retains the Internet address of the Foundation Page most recently displayed.
310 For any particular Display Device there is an Operating System that the PI-TRAMPING Service Module will have to use, in particular to get input commands from someone viewing Internet pages on that Display Device.
311 The channel or means by which the Operating System informs the PI-TRAMPING Service Module about relevant user actions.
320 For any particular Display Device there is an Internet Browser that the PI-TRAMPING Service Module will have to use, in particular to exchange information with the various Servers it will need to access
321 The channel or means by which the Internet Browser informs the PI-TRAMPING Service Module when the user moves to another Foundation Page.
330 The Initialization the PI-TRAMPING Service Module must perform so it will be notified when relevant actions are taken by the Operating System or Internet Browser.
331 The channel by which the PI-TRAMPING Service informs the Operating System which user actions it needs to know about.
332 The channel by which the PI-TRAMPING Service informs the Internet Browser what user actions it needs to know about.
333 After Initialization, the PI-TRAMPING Service Module makes this transition to a state in which it waits for events to which it must respond.
340 This part of the PI-TRAMPING Service Module is activated by a command from a human user to move on to a different page, or be notificated that a new Foundation page has been displayed.
341 The PI-TRAMPING Service Module makes this transition to a routine that decides which page to display next.
350 This part of the PI-TRAMPING Service Module keeps track which page is being displayed, decides which page to display next, and sends appropriate commands to the Internet Browser.
351 The channel by which the PI-TRAMPING Service tells the Internet Browser what page to display next.
352 After loading a next page, the PI-TRAMPING Service Module makes this transition back to Wait for Command

### DETAILED DESCRIPTION

### For a Natural Embodiment

As shown in FIGS. 1a and 1b, PI-TRAMPING Pages is an invention within the context of the Internet and any Display Device 100 connected to it and having enough computer processing power to retrieve Web pages from the Internet and display them on screen. In this description, such a page is called a Foundation Page Displayed 110a. A human viewer of such a display is well aware that a multitude of other Web pages is just a few finger moves away in some abstract space. These pages actually exist as computer files somewhere in the world, but conceptually the human view might imagine them as quite nearby. In FIG. 1a three such pages are suggested, the G-Page 120, the N-Page 130, and the I-Page 140. The G-Page 130 is meant to display generic advertisements such as they are today. The entire network of advertising marketers may continue to function unperturbed, simply by moving the display of their advertisements from any particular Web page where they are displayed today to its associated G-Page 120.

The N-Page 130 is meant to display a wider neighborhood of advertisements that will be arranged for through a company that supports the PI-TRAMPING Service. The I-Page 140 is meant to be a page of advertisements, amusements, and utilities that will serve to lure the human viewer across the other advertising pages to get to them. These three pages are created, sent through the Internet, and displayed just like any other Web page, the main difference being how the human viewer chooses to have them displayed. In this embodiment moving the on-screen cursor to the extreme right of the display will trigger the display of the next page in the sequence from Foundation through G-, N-, and I pages; and moving the on-screen cursor to the extreme left of a displayed page will trigger the display of the previous page in the said sequence. Moving the on-screen cursor to the extreme left of the Foundation Page Displayed 110a will do nothing, and moving the cursor to the extreme right of the I-Page will do nothing. FIG. 1b shows the situation just after the viewer gives the command to have the G-Page Displayed 120a. In the viewer's imagination the Foundation Page Displayed 110a has been replaced or just covered or pushed off-screen to the left by the G-Page Displayed 120a.

The larger context within which the PI-TRAMPING invention works, is shown in FIG. 2. Here the Display Device 100 is shown with attention to two particular parts, the display screen with a Foundation Page Displayed 110a and the PI-TRAMPING Service Module 200. The Display Device 100 is shown here with connections through the Internet (201, 202, 203, and 204) to the Foundation Page Server 210, the PI-TRAMPING Service 220, Information Utility Servers 240 of which there may be several, and Advertising Servers 250, of which there may be many. Besides preparing and sending advertising pages to people on the Internet, the PI-TRAMPING Service 220 will have its own servers and will use Internet connections (224, and 225) to make suitable business arrangements with the companies using the Advertising Servers 250 and the Information Utility Servers 240 and to gather from these companies the Universal Resource Locators to place material on the advertising pages when they are displayed. The PI-TRAMPING Service 220 will maintain a Database 230 of advertisers' and individual users' orders and interests to help it assemble materials for its advertising pages that will appeal to the users who view them.

The PI-TRAMPING Service Module 200 is what ensures the orderly transitions between the Foundation Page 110 and its associated G-Page 120, N-Page 130, and I-Page 140. In this embodiment it is created in any Display Device 100, by a Script for which the URL is downloaded with the HTML source for the Foundation Page 110. When the Internet Browser executes the Script, it will begin performing the functions of the PI-TRAMPING Service Module 200.

FIG. 3 shows the workings of the PI-TRAMPING Service Module 200 and its connections to other parts of the Display Device 100. To begin, there is an Initialization 330 in which the Operating System 310, through one of its regular channels 331, is informed which of a human viewer's actions the PI-TRAMPING Service Module 200 needs to be to informed about. In this embodiment the Operating System 310 will be made to report when the on-screen cursor is moved to the left or right edge of the screen on the Display Device 100. In a similar fashion the Internet Browser 320 will be informed through one of its regular communication channels 332 that it is to report back to the PI-TRAMPING Service Module whenever the Internet Browser 320 displays on-screen another Web page from the internet (other than the PI-TRAMPING advertising pages themselves). As part of the Initialization 330 a User ID 302 and Password 303 may be collected and saved from the human using the Display Device 100 so that person's interests, as known to the PI-TRAMPING Service from its Database 230, may be catered to in selecting materials to put on the N-Page 130 and the I-Page 140. The Initialization 330 will retrieve the address of the initial Foundation Page Displayed 110a from the Internet Browser and save it in memory as the Foundation Page Address 304. Finally the Initialization 330 will set the Page Flag 301 in its reserved memory to show that it is beginning with a Foundation Page Displayed 110a on the screen and pass control to its Wait for Command 340 routine.

The Wait for Command 340 routine is essentially a dormant state which does nothing until sent information from the Operating System 310 through one of its regular channels 311 that the human user has done something to signal that a new PI-TRAMPING page should be put on screen. In this embodiment that would be moving the on-screen cursor to the far right or far left of the screen. If a Foundation Page 110 is currently displayed and the on-screen cursor is on the far left of the screen, or, if an I-Page is currently displayed and the cursor is on the far right of the screen, the Wait for Command 340 routine does nothing but continue to wait. Otherwise, if the on-screen cursor is on the right of the screen, the Page Flag 301 is changed from its current value to a value representing the next page in this sequence: Foundation Page, G-Page, N-Page, I-Page. And if the on-screen cursor is on the left of the screen, the Page Flag 301 is changed from its current value to a value representing the next page in this sequence: I-Page, N-page, G-Page, Foundation Page. On the other hand, when the Internet Browser 320 sends a signal by way of one of its regular communication channels 321 to report that the human viewer has chosen to view an entirely different Web page, then the Page Flag 301 will be set to its Foundation Page setting and the address of the page that is about to be displayed will be retrieved from the Web Browser 320 and saved as the new value of the Foundation Page Address 304. Then the PI-TRAMPING Service Module 200 will remain in its Wait for Command 340 routine while the Internet Browser proceeds to put the new Foundation Page on the screen. Only when the Page Flag 301 is changed does the PI-TRAMPING Service Module 200 transition control 341 to its routine to Display Next Page 350

The Display Next Page 350 routine constructs an Internet address for the next page to be displayed and sends it through the normal channel 351 to instruct the Internet Browser 320 to retrieve that page and display it on screen. Then the PI-TRAMPING Service Module 200 returns to its Wait for Command 340 routine. The Page Flag 301 is examined and if the next page to be displayed is the Foundation Page 110 then the Foundation Page Address 304 is retrieved from memory and sent to the Internet Browser 320 for retrieval from the Internet and display. If the next page to be displayed is one of the advertising pages then a string of characters is constructed by concatenating the Internet address of the PI-TRAMPING Service 220 with the values stored in the Foundation Page Address 304, the Page Flag 301, the User ID 302, and the Password 303. In the concatenated string the five pieces are separated by appropriate characters. This string is sent to the Internet Browser 320 through the normal channel 351 to have it retrieved and displayed. Then the PI-TRAMPING Service Module 200 returns to its Wait for Command 340 routine.

### Operation for this Embodiment

In FIGS. 1a and 1b we can see how the operation of PI-TRAMPING Pages would work from a user's point of view. Any Page on the Internet would serve as a Foundation Page Displayed 110a on some Display Device 100. The three pages of advertising associated with it could be imagined to be nearby and the user could view them successively by moving the on-screen cursor to the far right edge of the screen, or review them successively by moving the on-screen cursor to the far left edge of the screen. At any point the user could type in a new Internet Address or click the on-screen cursor on an appropriate place on any of the PI-TRAMPING Pages, and the Internet Browser would retrieve a new page from the Internet that could serve as a new Foundation Page with a new set of associated pages of advertising.

In FIG. 2 we can trace how the operations of PI-TRAMPING Pages would work in the larger context of the Internet and World Wide Web. To begin, a person using the Display Device 100 would have some Internet Browser 320 running on it and could click on an active link or type in the Internet Address of a page to be displayed. The Internet Browser 320 would retrieve that page and display it. If it was a page that participated in the PI-TRAMPING Service 220 it would include in its HTML file a link for a Script file available at the PI-TRAMPING Service 220. The Internet Browser 320 would retrieve this Script file and run it, thereby starting up the PI-TRAMPING Service Module 200 on that Display Device 100. Now, by means of the PI-TRAMPING Service Module 200 the Internet Browser 320 behaves a bit differently; when the on-screen cursor is moved to the far right edge of the screen successive pages of advertising are displayed, and when the on-screen cursor is moved to the far left edge of the screen the pages of advertising are re-displayed in reverse order, right back to the Foundation Page 110 where it all started.

The display of the correct pages of advertising is managed between the PI-TRAMPING Service Module 200 and the PI-TRAMPING Service 220 itself. In response to the user's cursor motions the PI-TRAMPING Service Module 200 directs the Internet Browser 320 to retrieve an advertising page by sending 351 it an Internet address to use which is a string of characters constructed from the Internet address of the PI-TRAMPING Service 220 with data appended as parameters from the Foundation Page Address 304, the Page Flag 302, the User ID 302, and the Password 303. With this much information the PI-TRAMPING Service 220 could select and stitch together the HTML code for suitable advertisements for the various pages of advertising. This HTML code would contain the URLs for the advertisements and when sent back to the requesting Display Device 100 this would be enough for the said device to fill out the display of the advertising pages by requesting the files designated by the said URLs directly from the Advertising Servers 250 and Information Utility Servers 240 themselves.

And Finally, it would be useful, and normal practice for users to be able to contact the PI-TRAMPING Service 220 directly through the Internet and sign up for their own User IDs and Passwords and to indicate their particular interests in what kind of advertising they might want to see, and what kind of utilities they might want on their own individual I-Page 140.

### CONCLUSION, RAMIFICATIONS, AND SCOPE

While the above description contains many specifics, these should not be construed as limitations on the scope of any embodiment, but as an example. Many ramifications and variations are possible within the basic ideas of these embodiments. For example, the display of several pages of advertisements could be combined onto a single page. Or even more pages of advertisements could be displayed with (or without) different reasons for grouping the advertisements together. Alternate ways for the human viewer to move the display back and forth between the Foundation-Page and the advertising pages might be used For example gestures on a touch sensitive screen could be used in place of the cursor movements described above. Various particular features might be dropped, such as the use of User Ids and Passwords and still have the same basic functionality. Moreover computer programs can be written in a multitude of ways, in a great number of different programming languages, and installed in many places and ways in the computers that run them, and still perform the same functions. In particular, the PI-TRAMPLING functions may be made a part of an Operating System or a Web Browser, but any way of performing the functions necessary for the PI-TRAMPING pages to behave as described above should be considered within the scope of this PI-TRAMPING invention.

Thus the scope should be determined by the following claims and their legal equivalents, and not limited by the examples given above.

1. A method for placing any advertising that would normally appear on an Internet Web page, on separate advertising pages instead, such method comprising;
a. a module that runs on a computer display device and provides special means for a user of the device to switch from viewing any ordinary Internet Web page to viewing one or more special advertising pages associated with the ordinary Internet Web page,
b. said special means being different from the usual means by which a user switches from viewing one Internet Web page to another, and
c. said module causing the display device to request the advertising pages by sending over the Internet their Internet addresses with parameters appended to them which specify what advertising pages are to be returned; together with
d. an Internet server of Web pages which can interpret the parameters to decide exactly what page of advertising is to be returned.
